(19) United States
(12) Patent Application Publication
(10) Pub. No.: US 2003/0210221 A1
(43) Pub. Date: Nov. 13, 2003

(54) Portable device for providing LCD display and method thereof

(76) Inventor: Milivoje Aleksic, Richmond Hill (CA)

Correspondence Address: TOLER & LARSON & ABEL L.L.P., PO BOX 29567, AUSTIN, TX, 78755-9567, US

(21) Appl. No.: 10/141,030

(22) Filed: May 8, 2002

(51) Int. Cl. G09G 3/36

(52) U.S. Cl. 345/102

(57) ABSTRACT

A system and method are provided to conserve power consumption in a portable device having a liquid crystal display (LCD) screen with a backlight. The backlight provides light to support visibility of the LCD screen in low light conditions. A detector is used to identify an amount of ambient light that is incident to the LCD screen. Power generally provided to the backlight is modulated based on the amount of ambient light detected. As more ambient light is detected, less power is provided to the backlight. Power is conserved in the portable device by only providing enough power to the backlight to support the amount of ambient light available.

### FIELD OF THE DISCLOSURE

The invention is related generally to LCD displays and more particularly to LCD display backlighting.

### BACKGROUND

Liquid crystal display (LCD) technology is used to provide thin screens for various devices. Portable devices, such as laptop computers, portable digital assistants (PDA), calculators, portable televisions, and mobile phones, utilize LCD technology for low-power, thin screens. Some LCD screens, such as reflective LCD screens, are considered low power due to the low power used to activate LCD screen elements and their passive light characteristics. Fore example, reflective LCD screen elements are controlled to either reflect or pass ambient light dependent on received control signals.

Unfortunately, the available ambient light is not always enough to provide a visible screen for the user. Accordingly, a form of backlighting is coupled with LCD screens to either support the reflected ambient light, as in transreflective LCD screens, or replace the use of the ambient light, as in transmissive LCD screens. Several forms of backlighting are used, such as electroluminescent (EL), light emitting diode (LED), and cold cathode fluorescent lamp (CFL) backlighting. A user generally keeps the backlight disabled when ambient lighting is sufficient and enables the backlight when the screen is not readable due to low light conditions. Unfortunately, backlighting consumes a relatively large amount of power to generate the lighting for the LCD display. LCD screens substantially reduce the battery life of portable devices due to the amount of power consumed by the backlight.

From the above discussion, it should be appreciated that an improved method of supporting LCD screens in low light conditions is needed.

### BRIEF DESCRIPTION OF THE DRAWINGS

Specific embodiments of the present invention are shown and described in the drawings presented herein. Various advantages, features and characteristics of the present invention, as well as methods, operations and functions of related elements of structure, and the combination of parts and economies of manufacture, will become apparent upon consideration of the following description and claims with reference to the accompanying drawings, all of which form a part of this specification, and wherein:

FIG. 1 is a block diagram illustrating a system for providing an LCD display, according to one embodiment of the present invention;

FIG. 2 is a graph illustrating a relationship between detected ambient light and a modulated power provided for LCD backlighting, according to one embodiment of the present invention;

FIG. 3 is a block diagram illustrating a system for controlling LCD backlighting, according to one embodiment of the present invention;

FIG. 4 is a flow diagram illustrating a method of controlling LCD backlighting, according to one embodiment of the present invention;

FIG. 5 is a block diagram illustrating a system for providing a color LCD display, according to one embodiment of the present invention; and

FIG. 6 is a block diagram illustrating a system for controlling backlighting and color associated with an LCD display, according to one embodiment of the present invention; and

### DETAILED DESCRIPTION OF THE FIGURES

At least one embodiment of the present invention provides for a method of conserving power for LCD displays in low light conditions. The method includes applying a first power to a backlight to support an LCD with a first brightness. A first amount of ambient light is incident to the LCD. The LCD includes a transmissive display in which ambient light incident to the display is reflected to support visibility of the display. However, the backlight is used to provide further visibility when the ambient light is not enough. The method also includes detecting a second amount of ambient light. The second amount of ambient light is greater than the first amount of ambient light. The method further comprises, applying a second power to the backlight, to support the liquid crystal display at a second brightness. The second power is less than the first power. Accordingly, the present invention has the advantage of conserving power consumed by the backlight when more ambient light is available.

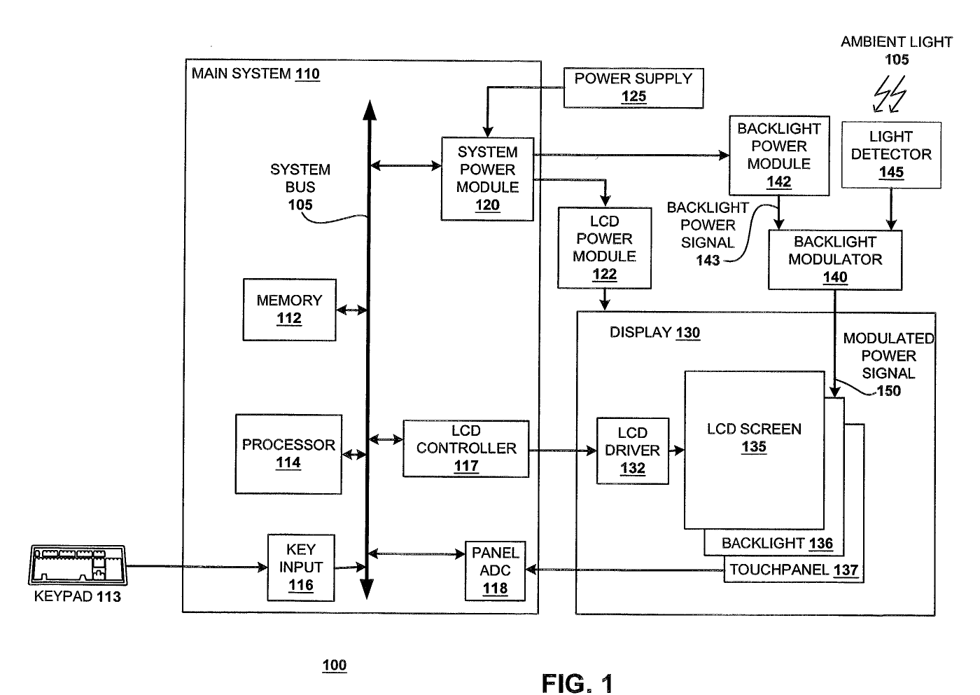

Referring now to FIG. 1, a block diagram illustrating a system for providing an LCD display is shown and generally referenced as portable device 100, according to one embodiment of the present invention. Portable device 100 includes a main system 110 for running applications and system functions of portable device 100, a keypad 113, a power supply 125 to provide power to portable device 100, and a display 130 to output images associated with portable device 100. Portable device 100 also includes an LCD power module 122 to power an LCD screen 132 of display 130, a backlight power module 142 to provide power to activate a backlight 136 of display 130, and a backlight modulator 140 to modulate power provided to backlight 136 based on ambient light 105 detected by light detector 145. Accordingly, backlight modulator 140 can be used to conserve power provided to backlight 136 by providing varying amounts of power when low light conditions exist.

Main system 110 handles most processes for portable device 100. Main system 110 includes a system bus 105 to couple components of main system 110, such as key input module 116, panel analog to digital converter (ADC) 118, LCD controller 117, memory 112 and power module 120, with a processor 114. Main system 110 receives user input through the key input module 116 coupled to a keypad 113. Keypad 113 can be used to detect user selections, such as through an external keyboard, a scroll button, or menu select keys. The key input module 116 translates signals from keypad 113 into commands to be processed by main system 110. The panel ADC 118 can decode user selections through a touch-panel 137 integrated within display 130.

Processor 114 interprets and executes instructions within main system 110. The processor 114 can also provide control over other portions of main system 110. Processor 114 can access portions of memory 112 to run applications. Memory 112 represents a form of data storage associated with main system 110. Memory 112 can include random access memory (RAM). Memory 112 can include a form of onboard memory, integrated with main system 110. Memory 112 can also include external memory, such as a flash memory card, or Smartmedia memory device. The processor 114 can also provide data to be displayed to LCD controller 117. LCD controller 117 can translate display data and commands from processor 114 into signals to be interpreted by the display 130.

Power to run components of main system 110, can be derived from an external power supply 125. In one embodiment, the power supply 125 includes a portable power source, such as batteries. A system power module 120 can be used to regulate and distribute power from power supply 125 to portions of portable device 100, including main system 110. In one embodiment, the system power module 120 also provides power from power supply 125 to an LCD power module 122 for powering portions of LCD screen 135 associated with display 130, and a backlight power module 142 for powering a backlight 136 associated with display 130.

In one embodiment, display 130 includes an LCD display. Accordingly, display 130 includes an LCD driver 132 to interpret signals provided by main system 110, through LCD controller 117. LCD driver 132 powers elements of LCD screen 135 to display characters and images of portable device 100. In one embodiment, a user depresses portions of LCD screen 135 to make selections. The touch-panel 137 detects the portions of LCD screen 135 selected by the user and provides signals associated with the selections to the panel ADC 118 of main system 110.

In one embodiment, LCD screen 135 includes a transreflective display. Elements of LCD screen 135 are powered to reflect light incident to LCD screen 135, such as ambient light 105, to generate images visible by the user. As an amount of ambient light 105 present may not be great enough to provide adequate visibility of the LCD screen 135 to the user, a backlight 136 can be provided. The backlight 136 provides light to LCD screen 136 to support the ambient light 105, improving visibility of the image on LCD screen 135 in low-light conditions. As previously discussed, a user generally selects to enable the backlight 136 when low-light conditions occur. Accordingly, backlight power signal 143 is provided for the backlight through the system power module 120 and the backlight power module 142.

While the backlight power module 142 provides a fixed power, backlight power signal 143, to enable the backlight 136, a backlight modulator 140 can provide an adapted power, modulated power signal 150, based on an amount of backlight needed, as is subsequently discussed. Several types of backlights can be used, such as electroluminescent (EL), light emitting diode (LED), or cold cathode fluorescent lamp (CFL) backlights, without departing from the scope of the present invention. The backlight 136 can remain active until either disabled by a user or by system power module 120 when low power is detected, such as due to a failing power supply 125. Furthermore, the backlight 136 can be disabled when ambient light 105 is found to be sufficient to support visibility.

An amount of voltage needed to power the backlight 136 can depend on a type of backlight being used. For example, EL type backlights require approximately 80 to 100 volts alternating current (VAC) to operate. Accordingly, the backlight power module 142 can include an inverter to convert the low direct current (DC) power supply generally provided through power supply 125, such as 5, 12 or 24 VDC, into the high alternating current (AC) voltage required for the EL backlight. LED backlights generally provide a longer operating life than EL backlights and are capable of operating off of 5 VDC; however, LED backlights consume more power than EL backlights. CFL backlights consume less power than EL backlights, but require an inverter to provide 270 to 300 VAC for operation.

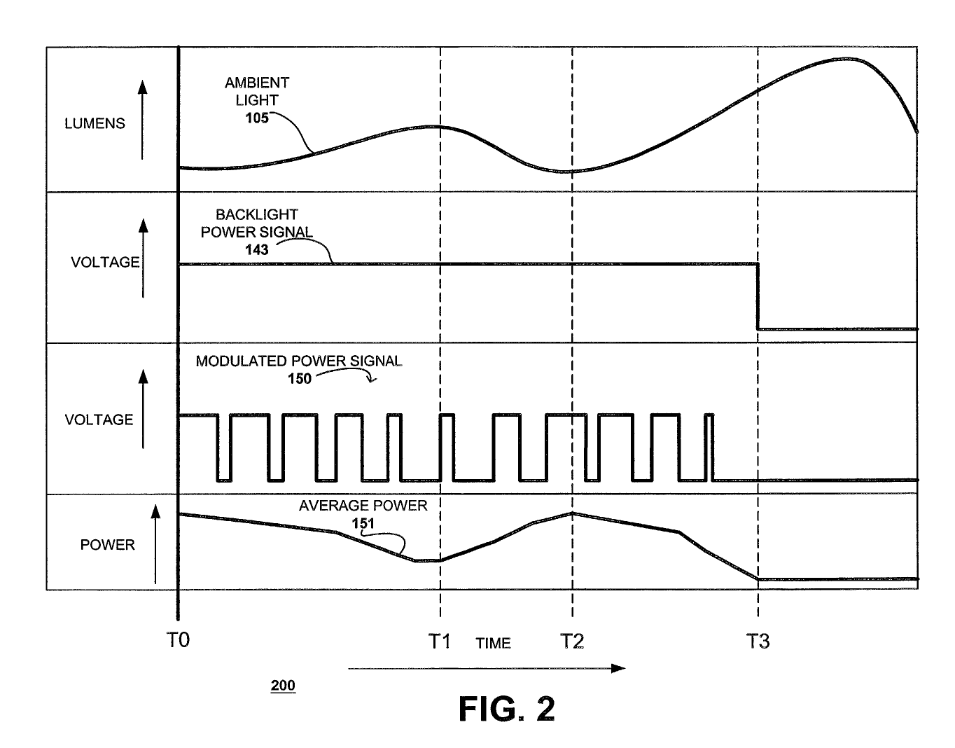

As the backlight 136 can substantially consume the power provided by the power supply 125, backlight modulator 140 regulates the power provided to the backlight 136 through the modulated power signal 150. In one embodiment, a light detector 145 identifies an amount of ambient light 105 present. The ambient light 105 represents an amount of visible light incident to the LCD screen 135. The amount of light detected is provided to the backlight modulator 140. In one embodiment, the backlight modulator 140 provides less power to the backlight 136 when more ambient light is present. Therefore, as more ambient light exists and less backlighting is necessary, less power is provided to the backlight 136. For example, in complete darkness, the backlight modulator 140 may allow all of the backlight power signal 143, provided by the backlight power module 142, to be passed to the backlight 136 as modulated power signal 150. However, as more ambient light is present, the backlight modulator 140 can modulate the backlight power signal 143, such as by switching the backlight power signal 143. In one embodiment, the backlight 136 is switched on and off for varying periods of time, reducing the amount of backlight provided and the amount of power consumed by backlight 136. As more ambient light is present, the backlight 136 can be switched into the “on” state for smaller periods of time, as better discussed with reference to FIG. 2.

Referring now to FIG. 2, a graph illustrating a collection of plots describing relationships between backlight power and ambient light is shown and referenced generally as plot 200, according to one embodiment of the present invention. Plot 200 represents a change in values of ambient light 105, backlight power signal 143, modulated power signal 150 and average power 151 in time, with reference to times T0, T1, T2 and T3. Ambient light 105 is illustrated in plot 200 according to a number of detected lumens. Backlight power signal 143 and modulated power signal 150 are illustrated in amounts of voltage provided and average power 151 is graphed with reference to measurements of power, such as watts. It should be noted that plot 200 is provided to illustrate a relationship between ambient light 105 and modulated power signal 150 and actual values of voltage and watts provided will vary dependent on the specific type of backlight used.

Plot 200 begins at time T0. At time T0, the backlight power signal 143 is high, indicating the backlight, such as backlight 150, is enabled. Since the detected ambient light 105 is relatively low at time T0, the amount of backlight power signal 143 used in modulated power signal 150 is high. Accordingly, modulated power signal 150 has a high duty cycle, leaving the backlight active for a greater amount of time than in an “off” state, wherein no power is provided to the backlight. Accordingly, the average power 151 at time T0 is relatively high. In comparison to time T0, at time T1, the ambient light 105 is higher. Accordingly, less of the backlight power signal 143 provided is used and modulated power signal 150 includes a shorter duty cycle than at time T0. Accordingly, the average power 151 is less at time T1 than at time T0. At time T2, the ambient light 105 decreases again and the duty cycle of the modulated power signal 150 is increased, in comparison to time T1. Similarly, the average power 151 at time T2 increases with respect to time T1.

At time T3, the backlight power signal 143 is switched off. The backlight power signal 143 may no longer be provided due to a detection of the ambient light 105 being too high, a detection of a low power supply or a selection by a user to disable the backlight 136. Accordingly, despite a change in ambient light 105 at time T3, the modulated power signal 150 is left in an ‘off’ state, and the average power 151 consumed is minimal. It should be appreciated that other methods of generating the modulated power signal 150 from the backlight power signal 143 can be used without departing from the scope of the present invention.

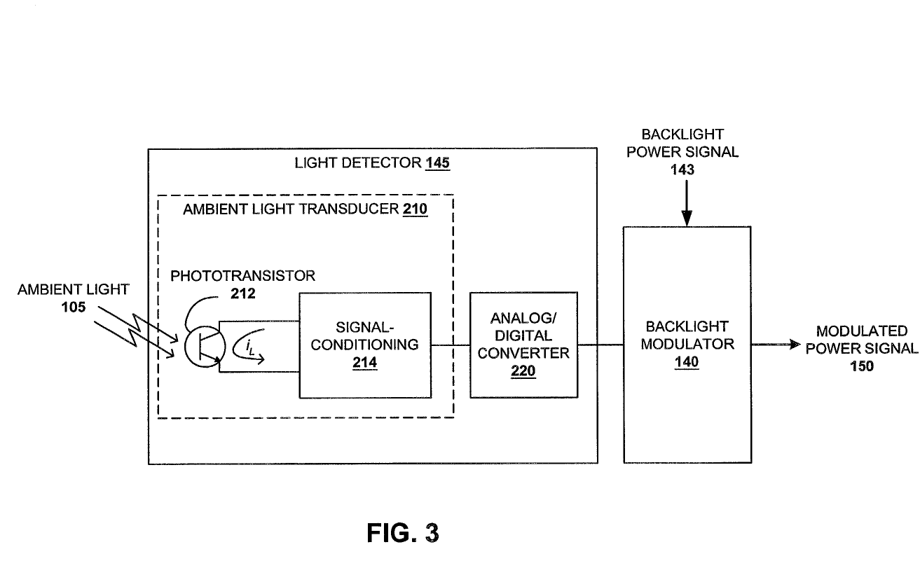

Referring now to FIG. 3, a block diagram illustrating a system for controlling LCD backlighting is shown, according to one embodiment of the present invention. Light detector 145 provides a signal representative of an amount of ambient light 105 present to backlight modulator 140. Backlight modulator 140 modulates received backlight power signal 143, based on the amount of ambient light 105 detected, to generate modulated power signal 150. Modulated power signal 150 provides lower power to a backlight, such as backlight 136 (FIG. 1), when a greater amount of ambient light 105 is detected.

Light detector 145 includes an ambient light transducer 210 to generate an analog signal based on the amount of ambient light 105. In one embodiment, the ambient light transducer 210 includes a phototransistor 212. Phototransistor 212 allows a greater amount of current i_{L} to flow when phototransistor 212 receives a greater number of photons associated with ambient light 105. A signal-conditioning block 214 is used to adapt the current i_{L} into a desired signal. For example, the signal-conditioning block 214 can generate a voltage signal which changes in relation to the current signal i_{L}. An ADC 220 is provided to convert the analog signal generated by the signal-conditioning block 214 into digital signals for providing control to backlight modulator 140.

In one embodiment, the backlight modulator 140 switches the backlight power signal 143 to generate the modulated power signal 150, based on the control signal provided by the ADC 220. The modulated power signal 150 can then be used to turn on and off the backlight 136. In another embodiment, the backlight modulator 140 can generate a control signal to disable the backlight 136. For example, the control signal can be provided to main system 110 of FIG. 1. It should be appreciated that other types of signals can be used without departing from the scope of the present invention. Other methods of generating control signals can also be used. For example, an analog signal generated by signal conditioning block 214 can be provided directly to backlight modulator 140 for control, without ADC 220. Furthermore, while a phototransistor 212 is shown for detecting the ambient light 105, other forms of light transducers can be used. For example, a photodiode can be used to detect the amount of ambient light 105 present. Furthermore, other forms of modulating the backlight power signal 143 can be performed without departing from the scope of the present invention.

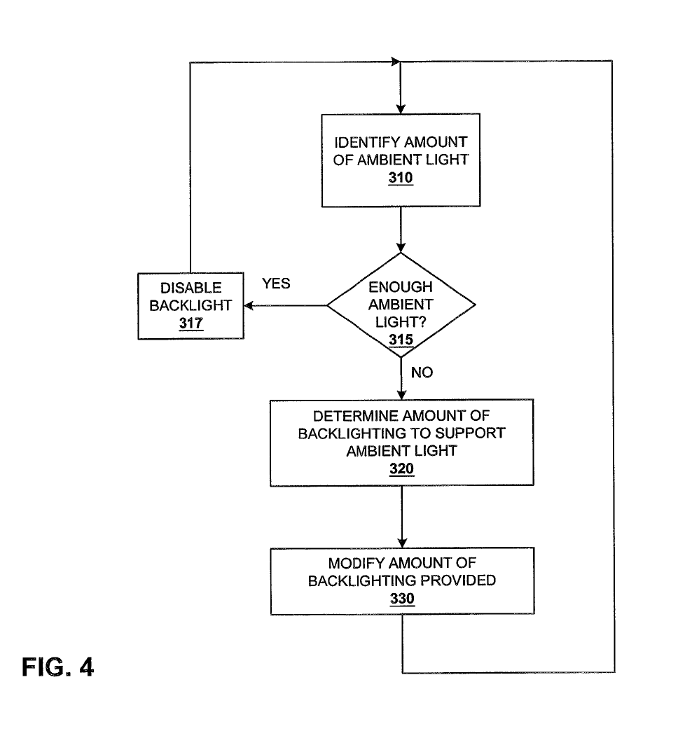

Referring now to FIG. 4, a flow diagram illustrating a method of controlling LCD backlighting is shown, according to one embodiment of the present invention. An amount of power provided to a backlight, such as backlight 136 (FIG. 1), used to support an LCD screen is modified based on an amount of ambient light detected. In step 310, the amount of ambient light is detected. A light transducer can be used to identify the amount of ambient light, as previously discussed. In an alternate embodiment, a color associated with the ambient light is also detected. In one embodiment, in step 315, it is determined if the amount of ambient light is large enough to support visibility of the LCD screen without further backlighting. In step 317, if enough ambient light for visibility was detected in step 315, the backlight is disabled. The system can then return to step 310 to continue monitoring the ambient light. Alternatively, if the amount of ambient light detected in step 315 is not sufficient, the system proceeds to step 320.

In step 320, an amount of backlighting needed to support the LCD screen is determined. The amount of backlighting needed can be based on a minimum amount of backlight desired to support adequate visibility of the LCD screen, based on the amount of ambient light. The amount of lighting can be calculated based on tests regarding a particular LCD screen, or taken from a look-up table. For example, a specific amount of backlighting can be used for a particular range of lumens of ambient light. In one embodiment, the amount of backlighting is represented as a proportion of a maximum power provided to turn on the backlight with a standard, or nominal, brightness. In another embodiment, a color correction of the LCD screen is also determined. If a dominant color of the ambient light was detected, the colors displayed on the LCD screen may appear distorted, due to the ambient light. Accordingly, the color of the LCD screen can be altered to correct for the distortion, keeping the colors viewed on the LCD screen to be constant despite changes in the color of the ambient light. The effect of maintaining viewed color is referred to herein as color constancy and is subsequently discussed.

In step 330, the amount of power provided to the backlight is modified based on the amount of backlighting detected in step 320. For example, a duty cycle used to provide power to the backlight can be altered based on the amount of backlight needed. For example, if 80 percent of the full backlight support is needed, a power signal with an 80 percent duty cycle can be provided to the backlight. After the amount of power provided has been modified, the amount of ambient light can be monitored again. In one embodiment, the measurements of ambient light are taken after set intervals of time. For example, the amount of ambient light can be checked once every minute. Accordingly, the amount of power provided to the backlight can be modified once ever minute. Furthermore, if a correction of color was determined in step 320, the color correction can be applied to either the backlight used or to characters to be displayed on the LCD screen.

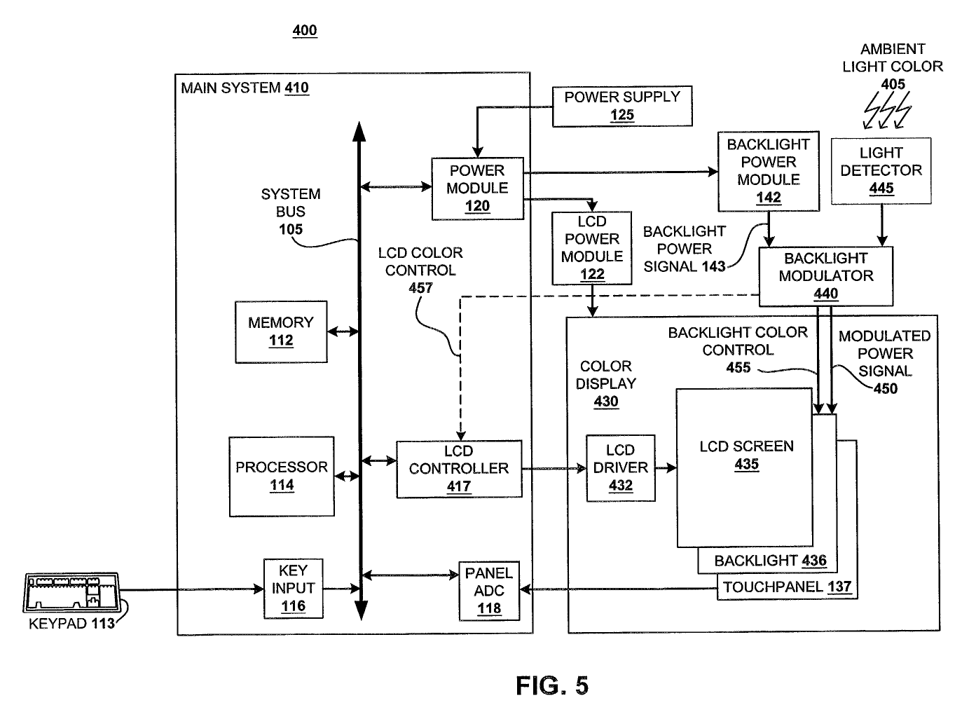

Referring now to FIG. 5, a block diagram illustrating a system for providing a color LCD display is shown and referenced generally as portable device 400, according to one embodiment of the present invention. Portions of portable device 400 operate similar to portable device 100 of FIG. 1. Differences between portable device 400 and portable device 100 are highlighted with reference to color display 430, LCD controller 417, light detector 445 and backlight modulator 440. While portable device 100 is capable of altering an amount of power provided to backlight 136 (FIG. 1) based on an amount of ambient light 105 (FIG. 1), portable device 400 is further capable of altering a set of colors displayed on color display 430 based on dominant colors of ambient light color 405 to improve color constancy.

While the light detector 145 of FIG. 1 is used to primarily identify an amount of ambient light present, light detector 445 is further capable of identifying a color, ambient light color 405, associated with the ambient light. For example, light detector 445 can identify an amount of light present in relation to each of a set of color components, such as a red component, a blue component and a green component. Accordingly, the light detector 445 can provide signals related to the intensities of each detected color component to the backlight modulator 440.

In one embodiment, the backlight modulator 440 uses the color component intensities provided by the light detector 445 to generate a modulated power signal 450 and a backlight color control 455. The modulated power signal 450 can represent a modulation of the backlight power signal 143 provided by the backlight power module 142. The backlight modulator 440 can generate the modulated power signal 450 to counter a lack of ambient light present, as previously discussed for backlight modulator 140. The backlight modulator 440 is further capable of generating the backlight color control 455 to counter a dominant color of ambient light color 405. The backlight modulator 455 can estimate an amount of ambient light based on the greatest color component intensity detected.

Colors associated with ambient light, such as ambient light color 405, can alter an appearance of colored characters, or images, on LCD screen 435 of color display 430. A dominant color falling incident to color display 430 can cause a color shift in which colors on LCD screen 435 will appear differently than in white ambient light. For example, a dominant red color can cause yellow characters to appear orange and blue characters to appear purple. Accordingly, the backlight modulator 440 can provide a backlight color control 455 to control a color used by backlight 436 to support LCD screen 435. In one embodiment, to identify the proper color for backlight 436 to apply, the ambient light color 405, detected by the light detector 445, is compared to a lookup table. The color used by the backlight 436 can counter the dominant color, ambient light color 405, detected in the ambient light. It should be noted that a proper color to apply can depend on a particular display being used and require subjective testing. Alternatively, the color to be used by the backlight 436 can be determined through algorithms used to evaluate correction factors for color constancy. Color constancy algorithms, such as the von Kries color constancy algorithm, identify correction factors for allowing a perceived color of a colored surface to remain constant over changing environment colors. It should be noted that other color constancy algorithms can be used to identify correction factors for improving color constancy without departing from the scope of the present invention.

Alternatively to providing the backlight color control 455 for correcting perceived colors of color display 430 using the backlight 436, the backlight modulator 440 can provide an LCD color control 457 to the main system 410. The LCD color control 457 can be used to shift colors being displayed on LCD screen 435 to correct for ambient light color 405. In one embodiment, the LCD controller 417 receives the LCD color control 457 and alters colors of pixels to be displayed based on the LCD color control 457. The altered pixels are then provided to the LCD driver 432. Accordingly, the backlight 436 can provide a constant white backlight of an intensity based on the modulated power signal 450, while the LCD controller 417 provides color constancy correction. It should be appreciated that other methods of correcting color constancy in color display 430 can be provided without departing from the scope of the present invention

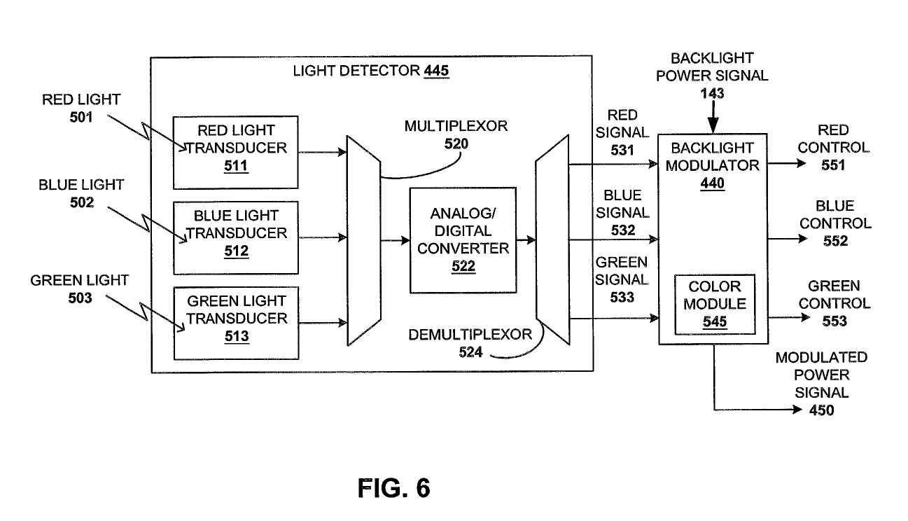

Referring now to FIG. 6, a block diagram illustrating a system for controlling backlighting and color associated with an LCD display is shown, according to one embodiment of the present invention. A light detector 445 having colored light transducers 511-513, a multiplexor 520, an ADC 522, and a demultiplexer 524 generates a set of signals 531-533 related to detected ambient light colors 501-503, respectively. A backlight modulator 440 generates color control signals 551-553 and modulated power signal 450 based on the received signals 531-533 and backlight power signal 143.

Light detector 445 includes transducers 511 to 513 to identify intensities of each of a set of ambient color components 501-503, respectively. For example, a red light transducer 511 identifies an amount of red light 501 present in ambient light. A blue light transducer 512 identifies an amount of blue light 502 present and a green light transducer 513 detects an amount of green light 503 present. In one embodiment the transducers 511-513 include colored light transducers, such as photodiodes, tuned to detect particular colors of light. For example, the blue light transducer 513 can include a photodiode that is activated by received light having wavelengths between 400-480 nm to detect an amount of blue light. Alternatively, the transducers 511-513 can include separate color filters to identify separate color components of light.

The multiplexor 520 selects one of the transducers 511-513 to accept signals from. Multiplexor 520 can then be used to provide each of the signals to the ADC 522. The ADC 522 generates digital signals corresponding to the analog signals from transducers 511-513. A demultiplexer 524 is used to identify which signals output from the ADC 522 correspond to which colored light 501-503. Accordingly, the demultiplexer 524 can provide digital color signals, red signal 531, blue signal 532 and green signal 533 to the backlight modulator 440 to represent the amount of red light 501, blue light 502 and green light 503, respectively. It should be appreciated that other methods of providing signals corresponding to the amounts of colored light may be used, without departing from the scope of the present invention. For example, separate ADCs can be used for each transducer 511-513, in place of using a multiplexor. However, it should be noted that the use of additional ADCs can increase an amount of power consumed by the light detector 445. Furthermore, it may not be desired to generate digital signals corresponding to the amount of color and the analog signals provided by the transducers 511-513 may be sufficient for the backlight modulator 440.

In one embodiment, backlight modulator 440 generates a modulated power signal 450 based on the backlight power signal 143 and the received signals 531-533. The modulated power light 450 represents an amount of power provided to the backlight. In one embodiment, the maximum power provided to the backlight is represented by the backlight power signal 143, provided by a backlight power module, such as backlight power module 142 (FIG. 5). The received color signals 531-533 can be analyzed to represent a total amount of ambient light available. The backlight power signal 143 is used to generate the modified power signal 450 that controls an intensity of the backlight. The modified power signal 450 provides less power to the backlight when intensities associated with lights 501-503 are high and less intensity is needed. Accordingly, less power can be consumed by the backlight when more ambient light exists.

In one embodiment, the backlight modulator 440 uses a color module 545 to generate color control signals, red control 551, blue control 552 and green control 553. The color control signals 551-553 are used to correct for color constancy problems as the color of ambient light changes. As the color of ambient light changes, displayed colors can be altered to allow the images on a screen to be viewed properly. The color module 545 can provide correction factors for control signals 551553 to correct for colors identified through color signals 531-533. In one embodiment, the correction factors to correct for a lack of color constancy can be determined through a lookup table. It should be appreciated that other methods of identifying the control signals 551-553 based on the color signals 531-533 can be used without departing from the scope of the present invention. For example, the control signals 551-553 can be determined through a color constancy algorithm, as previously discussed.

In one embodiment, the color control signals 551-553 are used to determine a color to be provided by the backlight. By providing a colored backlight, characters to be displayed on the LCD can be shifted in color to correct for a color of the ambient light. In an alternate embodiment, the color control signals 551-553 are provided to shift colors to be displayed on the LCD automatically. Each color to be displayed is modified internally by a portable device generating the images to be displayed. It should be appreciated that other methods can be used to support color constancy and ambient light intensity without departing from the scope of the present invention.

The systems described herein may be part of an information handling system. The term “information handling system” refers to any system that is capable of processing information or transferring information from one source to another. An information handling system may be a single device, such as a computer, a hand held computing device, a cable set-top box, an Internet capable device, such as a cellular phone, and the like. Alternatively, an information handling system may refer to a collection of such devices. It should be appreciated that while components of the system have been describes in reference to video processing components, the present invention may be practiced using other types of system components. It should be appreciated that the system described herein has the advantage of conserving power while supporting an LCD display in low light conditions.

In the preceding detailed description of the embodiments, reference has been made to the accompanying drawings which form a part thereof, and in which is shown by way of illustration specific embodiments in which the invention may be practiced. These embodiments are described in sufficient detail to enable those skilled in the art to practice the invention, and it is to be understood that other embodiments may be utilized and that logical, mechanical and electrical changes may be made without departing from the spirit or scope of the invention. To avoid detail not necessary to enable those skilled in the art to practice the invention, the description may omit certain information known to those skilled in the art. Furthermore, many other varied embodiments that incorporate the teachings of the invention may be easily constructed by those skilled in the art. Accordingly, the present invention is not intended to be limited to the specific form set forth herein, but on the contrary, it is intended to cover such alternatives, modifications, and equivalents, as can be reasonably included within the spirit and scope of the invention. The preceding detailed description is, therefore, not to be taken in a limiting sense, and the scope of the present invention is defined only by the appended claims.

What is claimed is:

1. A method of configuring a portable device having a display comprising the steps of:
identifying an ambient light characteristic, wherein the ambient light characteristic includes an amount of visible light;
identifying a display characteristic to provide adequate display visibility based on the ambient light characteristic; and
modifying the display to match the display characteristic.

2. The method as in claim 1, wherein the display characteristic includes an amount of brightness associated with the display.

3. The method as in claim 2, wherein the step of modifying the display to match the display characteristic includes altering an amount of power provided to a backlight used to support the display.

4. The method as in claim 3, wherein the backlight includes one of an electroluminescent backlight, a light emitting diode backlight, or a cold cathode fluorescent lamp backlight.

5. The method as in claim 1, wherein the step of modifying the display is performed to conserve power while still providing adequate display visibility.

6. The method as in claim 1, wherein the ambient light characteristic further includes a dominant color of the ambient light characteristic.

7. The method as in claim 6, wherein the display characteristic includes a display color enhanced to improve color constancy based on the dominant color of the ambient light.

8. The method as in claim 7, wherein the display color is determined through a color constancy algorithm.

9. The method as in claim 1, wherein the amount of visible light is measured incident to the display.

10. The method as in claim 1, wherein the display includes a liquid crystal display.

11. A method comprising:
applying a first power to a backlight to support a liquid crystal display at a first brightness, wherein a first amount of ambient light is present;
detecting a second amount ambient light, greater than the first amount of ambient light; and
applying a second power to the backlight to support the liquid crystal display at a second brightness, wherein the second power is less than the first power.

12. The method as in claim 11, wherein the liquid crystal display includes a transreflective liquid crystal display.

13. The method as in claim 11, wherein the first amount of ambient light and the second amount of ambient light are measured incident to the liquid crystal display.

14. The method as in claim 11, wherein the step of applying the second power to the backlight is performed to reduce an amount of power consumed by the backlight.

15. The method as in claim 11, wherein the second brightness is less than the first brightness.

16. The method as in claim 11, wherein the liquid crystal display having the first brightness with the first amount of ambient light has similar visibility as the liquid crystal display having the second brightness with the second amount of ambient light.

17. The method as in claim 11, wherein backlight includes one of an electroluminescent backlight, a light emitting diode backlight, or a cold cathode fluorescent lamp backlight.

18. A portable device comprising:
a light transducer to generate a signal representative of an amount of ambient light;
a backlight to provide light to a display;
said display; and
a backlight modulator coupled to receive the signal of the light transducer, said backlight modulator to control a power of said backlight to support said display based on the signal of the light transducer.

19. The portable device of claim 18, wherein said display includes a liquid crystal display.

20. The portable device of claim 18, said light transducer is further capable of identifying a dominant color associated with the ambient light.

21. The portable device of claim 20, wherein said backlight modulator further used to modify colors of said display to support color constancy of said display based on the dominant color of the ambient light.

22. The portable device of claim 20, wherein said backlight modulator further includes a lookup table to identify a correction factor to modify said colors based on said dominant color of the ambient light.

23. The portable device of claim 20, wherein said backlight modulator further used to calculate a correction factor to modify said display to support color constancy of said display based on said dominant color of the ambient light.

24. The portable device of claim 18, wherein said light transducer includes a phototransistor.

25. The portable device of claim 18, wherein said light transducer includes a photodiode.

26. The portable device of claim 18, wherein said light transducer detects said amount of ambient light incident to said display.

27. The portable device of claim 18, further including an analog to digital converter to couple an output of said light transducer to said backlight modulator.
